(19) United States
(12) Patent Application Publication
(10) Pub. No.: US 2018/0360265 A1
(43) Pub. Date: Dec. 20, 2018

(54) THIRTEEN CUP MUFFIN PAN WITH SIDE GRIPS FOR IMPROVED PAN GRIP

(71) Applicant: Jeffrey Mark Parrish, Sullivan's Island, SC (US)

(72) Inventor: Jeffrey Mark Parrish, Sullivan's Island, SC (US)

(21) Appl. No.: 15/623,534

(22) Filed: Jun. 15, 2017

(51) Int. Cl. A47J 37/01; A21B 3/13

(52) U.S. Cl. CPC A47J 37/01; A21B 3/13

(57) ABSTRACT

A baking pan includes two rows of two muffin cups and three rows of three muffin cups, thus creating thirteen muffin cups, or “a baker's dozen.” The baking pan includes a distance space created on the pan adjacent to each side of the row of two muffin cups. Silicone grips are places within at least two of these distance spaces on opposite sides of the muffin tray, allowing for easy gripping of the baking pan, thus avoiding damage to the muffin or other baked good.

### BACKGROUND OF THE INVENTION

The present invention relates to muffin pans, and more particularly, to an improved muffin pan with side grips and thirteen muffin cups.

Bakery products, and particularly muffins, are a common breakfast item. Common muffins include bran, blueberry, poppy seed, banana and banana-nut, lemon, cranberry, and others. In addition to being eaten for breakfast, muffins are often consumed as snack items throughout the day. Often, people make their own muffins or they purchase muffins from a bakery.

Conventional muffin pans include twelve muffin cups. When a baker only bakes a dozen muffins in a conventional muffin pan, he cannot sample any muffin for quality control, as industry standards dictate a dozen muffins for sale or gift. The pans presently available limit the baker and leaves them helpless regarding sampling their product, while still being left with the necessary dozen needed for sale or gift.

Further, bakers must grip the muffin tray from the edges of the pan to avoid damaging the muffins. Often, in error, a baker may push his thumb(s) into a muffin while trying to grab the tray.

There exists a need for an improved muffin pan, which allows an additional muffin for sampling by the baker, and allows for a gripping mechanism with no risk of damaging the muffin.

### SUMMARY OF THE INVENTION

The current invention relates to a baking pan comprising a baking surface defining a plurality of receptacles. The receptacles form two rows of two receptacles, wherein a distance space of at least 0.75 inches is between each receptacle and an edge of the baking pan. The baking further included three rows of three receptacles.

In one embodiment, the baking pan includes a silicone grip attached to the distance space. In one embodiment, the silicone grip is integral to the pan within the distance space.

In another embodiment, the baking pan includes at least two grips, wherein each grip is within distance spaces on opposite sides of the pan to allow a user to grip each side of the baking pan.

In one embodiment, the two rows of two receptacles can be positioned at a proximal and distal end of the baking pan, with the three rows of three receptacles being in the center of the baking pan.

In another embodiment, the three rows of three receptacles are separated by the two rows of two receptacles falling between them.

In one embodiment, each receptacle is configured to hold muffin batter. In another embodiment, each receptacle comprises a raised edge around a circumference of its opening.

In another embodiment, a baking pan comprises a baking surface defining a plurality of receptacles, wherein the receptacles form two rows of two receptacles, wherein a distance space of at least 0.75 inches is between each receptacle and an edge of the baking pan, and three rows of three receptacles. The baking pan further includes a silicone grip positioned in at least two of the distance spaces on opposite sides of the baking pan.

In one embodiment, the baking pan further includes two additional silicone grips within the remaining distance spaces.

In another embodiment, a baking pan comprises a baking surface defining a plurality of receptacles each comprising a conical shape, wherein the plurality of receptacles form three rows of no more than three receptacles, and two rows of no more than two receptacles, wherein the three receptacle rows alternate with the two receptacle rows.

In another embodiment, wherein the conical shape of each receptacle is frusto conical.

These and other features, aspects and advantages of the present invention will become better understood with reference to the following drawings, description and claims.

### BRIEF DESCRIPTION OF THE DRAWINGS

FIG. 1 is a perspective view of a muffin pan;

FIG. 2 a top view of the muffin pan;

FIG. 3 is a section view of the muffin pan taken along line 3-3 of FIG. 2; and

FIG. 4 a perspective view of an alternative embodiment of the muffin pan.

### DETAILED DESCRIPTION OF THE INVENTION

A description of preferred embodiments of the invention follows. Bakers using a conventional muffin pan often struggle with not being able to sample their creations, since a dozen muffins are required for sale or gift.

Additionally, bakers often struggle with quickly removing muffin pans from the oven and can accidentally damage one or more muffins by digging their thumb(s) into a muffin(s) since the muffin cups are so close to the edge of the pan.

The present invention is an improved muffin pan that has thirteen muffin cups, and convenient grips on the pan for easy gripping to avoid muffin damage. Although the pan of the present invention can be a pan for baking any items such as muffins, cakes, cupcakes, rolls, doughnuts, bagels, and other such items, the following description is directed to a pan for baking muffins therein. It is understood that the features of this muffin pan can be incorporated into a pan for other bakery items and remain within the scope of this invention.

Thirteen baked goods, or the term, “baker's dozen,” originates from European history. One theory is that in times when bread was sold by weight, bakers who short weighted their customers were heavily fined, and for safety's sake they would sell thirteen loaves for the price of twelve. The baker's dozen however, was never used as a means of convenience, or to allow the baker to sample a baked good prior to selling.

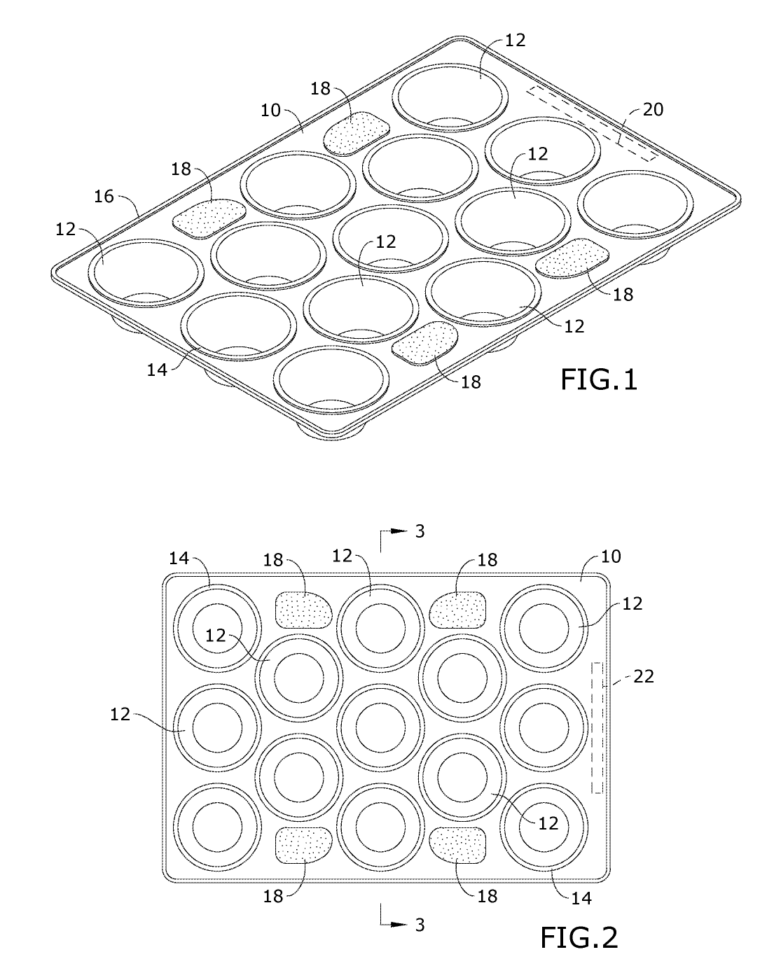

Referring now to the Figures, one embodiment of a muffin pan according to the present invention is show. In FIG. 1, a muffin pan 10 has a generally planar top surface. The pan 10 includes a set of thirteen receptacles or muffin cups 12. Each muffin cup 12 is sized and shaped to hold an amount of muffin batter and to retain the muffin once baked. The pan 10 also includes an area 20 where a logo can be inserted. The pan 10 further includes a pan lip 16, or slightly raised frame around a perimeter of the pan 10.

Because of the thirteen cups, the pan is not configured in equivalent rows to accommodate a dozen cups, as in a traditional muffin pan. In one embodiment, the muffin cups 12 are arranged in three rows of three cups with two rows of two cups between each row of three. The rows of two cups 12 are positioned towards the center of each row. Advantageously, this leaves a gap space of at least one 0.75 inches adjacent to each of the two cups on opposite sides of the pan.

In one embodiment, a plurality of grips 18 are attached to the pan in each adjacent gap next to each muffin in the rows of two muffins. Alternatively, the grips 18 are integrated into the pan. In one embodiment, the grips can be silicone, rubber, or any suitable heat resistant material.

In one embodiment, the grips 18 allow a user an area of the pan to grip, such that their thumbs (or another finger) do not touch or damage the muffin. The grip can be any suitable size or shape to fit within the gap and accommodate at least a thumb of an average sized individual. A top view of the muffin pan is shown in FIG. 2.

It should be understood that the configuration of the pan can be changed, such that the rows of two muffins are at a proximal or distal end of the pan 10 and the three rows of three muffin cups 12 fall in the center of the pan. The grips 18, however, are on each side of the row of two muffin cups 12 within the gap spaces created on the pan 10. Though four grips 18 are shown in the current embodiment, it should be understood that the pan can include only two grips 18; one on each side of the pan such that a user has at least one grip for each hand.

In one embodiment, the overall size of pan 10, can be any suitable size. In one embodiment, standard muffin pans are 11 ½″×16″. It is to be understood that the size of the pan may be more or less, depending on the desired overall size and the oven or other storage container into which pan 10 must fit. It is preferred that pan 10 is sized and shaped to optimally fit on a flat baking tray. Similarly, the shape of pan 10 is generally square or rectangular to accommodate the thirteen muffin cups in the configuration of rows as previously described. In one embodiment, the pan 10 can be circular or spherical.

By the pan having two rows of two muffins, it advantageously can create a better air flow to the center of the pan, thus giving a more even bake to the muffins in the middle. Further, it allows the baker to use the low estimate of cooking times in a recipe, therefore saving energy. Further, it conserves cooking time for the baker.

The size of the muffin cups 12 can be any suitable size. Generally, muffin cups 12 can be sized to hold as little as one ounce of batter or dough or less. Alternately, muffin cups 12 can be sized to hold as much as twelve ounces of batter or dough, or even more. Each muffin cup 12 s intended to be lined with a paper or foil liner prior to having the batter inserted therein, although for some muffins no liner is desired.

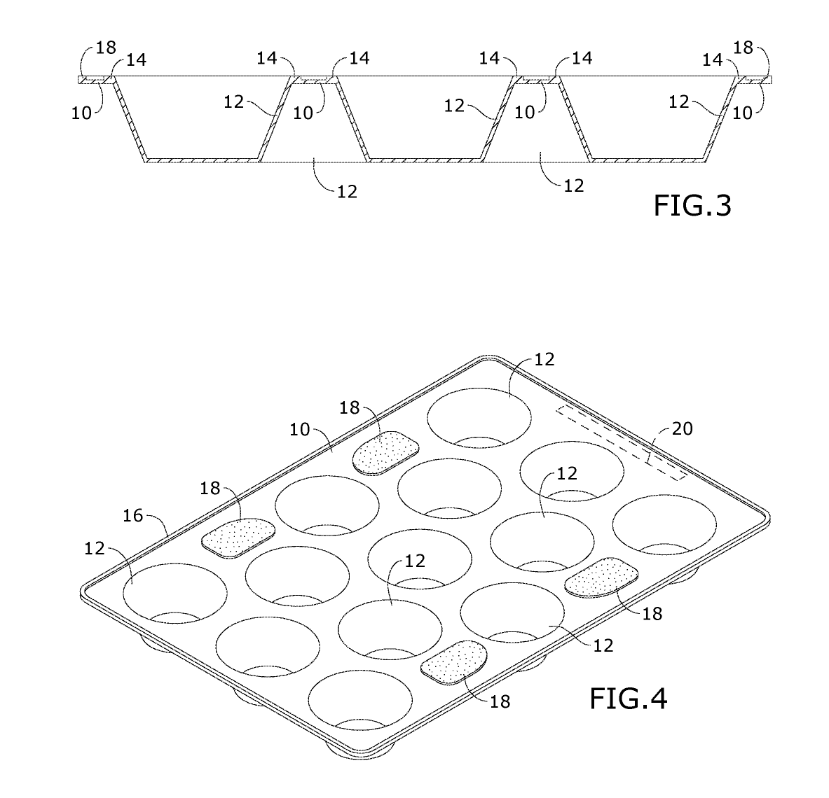

FIG. 3 shows a sectional view of the pan 10 of FIG. 2 taken along section 3-3. A row of the two muffin cups 12 is shown with adjacent grips 18 on each side of a muffin cup in the gap spaces next to each muffin cup on the pan 10.

FIG. 4 shows an alternative embodiment where each cup has a slightly raised cup lip 14 around a circumference of each cup 12. The cup lip 14 serves as a barrier to avoid the batter spilling into the body of the pan 10, and keeps the batter within each cup 12.

It should be understood, of course, that the foregoing relates to exemplary embodiments of the invention and that modifications may be made without departing from the spirit and scope of the invention as set forth in the following claims.

What is claimed is:

1. A baking pan comprising:
a baking surface defining a plurality of receptacles, the receptacles forming:
two rows of two receptacles, wherein a distance space of at least 0.75 inches is between each receptacle and an edge of the baking pan; and
three rows of three receptacles.

2. The baking pan of claim 1, where a silicone grip is attached to the distance space.

3. The baking pan of claim 1, wherein a silicone grip is integral to the pan within the distance space.

4. The baking pan of claim 1 comprising at least two grips, each grip within distance spaces on opposite sides of the pan to allow a user to grip each side of the baking pan.

5. The baking pan of claim 1, wherein the two rows of two receptacles can be positioned at a proximal and distal end of the baking pan, with the three rows of three receptacles being in the center of the baking pan.

6. The baking pan of claim 1, wherein the three rows of three receptacles are separated by the two rows of two receptacles falling between them.

7. The baking pan of claim 1, where each receptacle is configured to hold muffin batter.

8. The baking pan of claim 1, where each receptacle comprises a raised edge around a circumference of its opening.

9. A baking pan comprising:
a baking surface defining a plurality of receptacles, the receptacles forming:
two rows of two receptacles, wherein a distance space of at least 0.75 inches is between each receptacle and an edge of the baking pan;
three rows of three receptacles; and
a silicone grip positioned in at least two of the distance spaces on opposite sides of the baking pan.

10. The baking pan of claim 9 further comprising two addition silicone grips within the remaining distance spaces.

11. A baking pan comprising:
a baking surface defining a plurality of receptacles each comprising a conical shape, wherein the plurality of receptacles form:
three rows of no more than three receptacles; and
two rows of no more than two receptacles, wherein the three receptacle rows alternate with the two receptacle rows.

12. The baking pan of claim 1, wherein the conical shape is a frusto conical.
